(19) United States
(12) Patent Application Publication
(10) Pub. No.: US 2005/0023138 A1
(43) Pub. Date: Feb. 3, 2005

(54) Gas sensor with sensing particle receptacles

(75) Inventors: Wen-Jeng Huang, Tu-Cheng (TW); Chuan-De Huang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/927,806

(22) Filed: Aug. 27, 2004

(30) Foreign Application Priority Data
Mar. 9, 2003 (TW) 092124285

(51) Int. Cl. G01N 27/26; G08B 23/00

(52) U.S. Cl. 204/426; 204/424

(57) ABSTRACT

A gas sensor (3) includes an insulating substrate (31), two electrodes (33, 35) formed thereon, and a sensing layer (37) formed on the insulating substrate and the electrodes. Each electrode defines a plurality of receptacles (332, 352) adjacent a surface thereof The sensing layer contains a plurality of sensing particles (372). A portion of the sensing particles is received in the receptacles. The sensing particles are physically divided into several connected parts by the receptacles, and accordingly are highly dispersed. Thereby, more spaces among the sensing particles are provided, for improving the sensitivity of the gas sensor.

### BACKGROUND OF THE INVENTION

1. Field of the Invention

The present invention relates generally to sensors for use in gas-reactive applications, and more particularly to gas sensors having sensing layers containing oxide-semiconductor particles.

2. Description of Related Art

Gas sensors for detecting oxidizing and reducing gases, such as O₂, CO₂, CO, SO₂ or H₂, are employed in numerous Applications relating to personal safety, industrial process control and environmental protection. As one example, gas sensors are used in modern automobiles to provide exhaust emission feedback control as well as to monitor the performance of components such as the fuel injection system, the exhaust gas recirculation valve, and the catalytic converter.

A common type of gas sensor uses an oxide-semiconductor as a sensing layer. The gas sensor operates on the principle that absorption of a detected gas on a surface of the sensing layer causes a change in a conductive coefficient thereof the change resulting in a corresponding change of an electrical current or voltage which is measured

Spaces among oxide-semiconductor particles in the sensing layer should be reserved, m order to provide a larger contact surface and increase absorption of the detected gas. This is an important factor in obtaining a fast response time and high sensitivity for the gas sensor.

Taiwan Patent Issue No. 182029 discloses a gas sensor and a method for making the gas sensor. The gas sensor includes a sensing layer containing metal oxide particles. The sensing layer is formed by. (1) coating a solution containing metal oxide particles onto a buffering layer of a substrate to form a film, the coating being performed by way of spin-on deposition; and (2) sintering the film at 800° C. to thereby form the sensing layer.

However, because the sintering process is performed at a high temperature, most of spaces among the metal oxide particles in the sensing layer are reduced in size or even eliminated. This reduces the capability for the absorption of detected gases. The response time of the gas sensor is increased and the sensitivity of the gas sensor is reduced

Thus there is a need to efficiently reserve spaces among oxide-semiconductor particles in a sensing layer, in order to improve the sensitivity of gas sensors.

### SUMMARY OF THE INVENTION

In view of the above-described shortcomings, an object of the present invention is to provide a gas sensor which has a sensing layer including sensing particles that are highly dispersed

In one aspect of the present invention, there is provided a gas sensor comprising an insulating substrate, two electrodes formed thereon, and a sensing layer formed on the insulating substrate and the electrodes. Each electrode defines a plurality of receptacles adjacent a surface thereof. The sensing layer contains a plurality of sensing particles, and a portion of the sensing particles is received in the receptacles.

In another aspect of the present invention, there is provided a gas sensor comprising an insulating substrate, two electrodes formed thereon, and a sensing layer formed on the insulating substrate and covering surfaces of the electrodes. The insulating substrate defines a plurality of receptacles in a surface thereof and the electrodes cover inner surfaces of the receptacles. The sensing layer contains a plurality of sensing particles, and a portion of the sensing particles is received in the receptacles.

Preferably, the sensing particles are sized in the range from 5 nanometers to 100 nanometers. The sensing particles may for example be made of tin oxide, wolframium oxide, or zinc oxide. A ratio of an average depth of the receptacles to an average width of the receptacles is approximately ten. A ratio of the average width of the receptacles to an average size of the sensing particles is in the range from 2 to 3. A material of the insulating substrate may for example be quartz, a ceramic material, or silicon nitride. The receptacles are blind holes or channels, and are formed in the electrodes or the insulating substrate by etching or lithography. The gas sensor may further comprise a heating device adjacent the insulating substrate.

In summary, the receptacles receive sensing particles of the sensing layer. The sensing particles are physically divided into several connected parts by the receptacles, and accordingly are highly dispersed Thereby, more spaces among the sensing particles are provided, for improving the sensitivity of the gas sensor.

These and other features, aspects and advantages of the invention will become more apparent from the following detailed description, claims, and the accompanying drawings.

### BRIEF DESCRIPTION OF THE DRAWINGS

FIG. 1 is a schematic, cross-sectional view of a gas sensor in accordance with the preferred embodiment of the present invention

FIG. 2 is an enlarged view of a circled portion II of FIG. 1.

FIG. 3 is a schematic, cross-sectional view of a gas sensor in accordance with an alternative embodiment of the present invention.

FIG. 4 is an enlarged view of a circled portion IV of FIG. 3.

### DETAILED DESCRIPTION OF THE PREFERRED EMBODIMENT OF THE PRESENT INVENTION

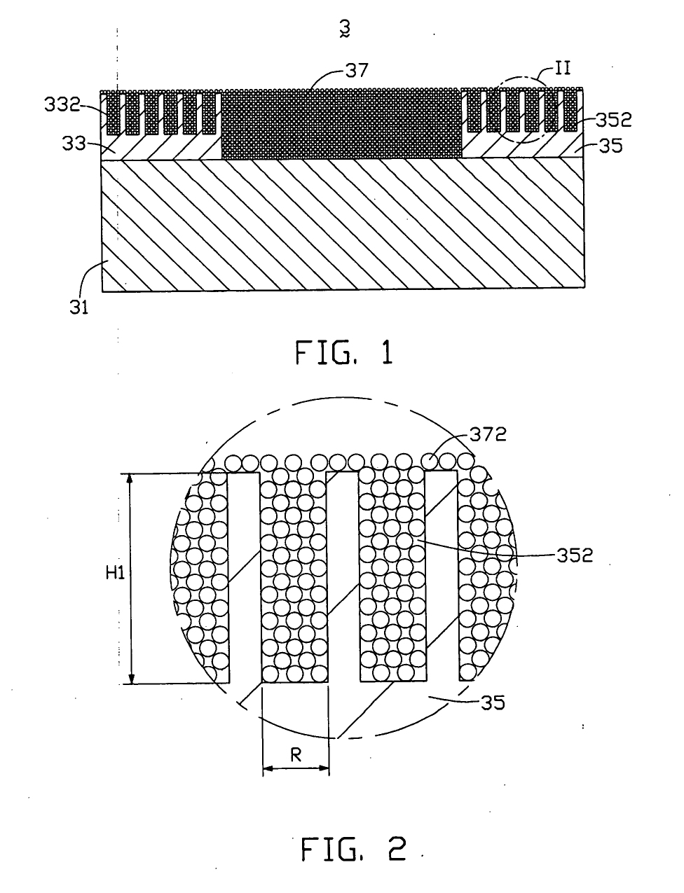

With reference to FIG. 1, there is shown a gas sensor 3 for detecting the presence of a gas in accordance with a preferred embodiment of the present invention. The gas sensor 3 comprises an insulating substrate 31, two separated electrodes 33, 35, and a sensing layer 37 formed on the substrate 31 and electrodes 33, 35. Each electrode 33, 35 defines a plurality of blind holes 332, 352 respectively. The sensing layer 37 covers surfaces of the electrodes 33, 35, and contains a plurality of sensing particles 372. Some sensing particles 372 are received in the blind holes 332, 352.

The insulating substrate 31 is a thin sheet or film, and is generally made of an insulating material such as quartz, a ceramic material, silicon nitride or the like. Further, the insulating material of the insulating substrate 31 preferably has a high thermal conductivity. This is because the gas sensor 3 needs to be heated in the process of manufacturing, and usually operates at high temperatures.

The electrodes 33, 35 are made of a metallic material such as platinum, gold, or an alloy thereof The electrodes 33, 35 are formed on a surface of the insulating substrate 31 by way of a deposition process. Alternatively, a sputtering process may be employed to form the electrodes 33, 35. Preferably, the electrodes 33, 35 are thick films, with a thickness in the range from 400 nanometers to 7,000 nanometers.

Referring to FIG. 2, a portion of the gas sensor 3 is shown enlarged The sensing particles 372 are made of tin oxide, wolframium oxide, zinc oxide, or another similar oxide-semiconductor material. Sizes of the sensing particles are preferably in the range from about 5 nanometers to about 100 nanometers. The sensing layer 37 is coated on the insulating substrate 31 and the surface of the electrodes 35 by any of various known coating methods, such as a sol-gel process, sputtering, or deposition.

The blind holes 332, 352 are formed by etching the electrodes 33, 35. Alternatively, any one of various lithography processes may be employed to form the blind holes 332, 352. The blind holes 332, 352 provide spaces for holding some of the sensing particles 372. Preferably, a ratio of an average diameter R of the blind holes 332, 352 to an average size of the sensing particles 372 is in the range from 2 to 3. A ratio of an average depth H1 of the blind holes 332, 352 to the average diameter R is ten. As a result, the sensing particles 372 are divided into several connected parts by the blind holes 332, 352, and accordingly are highly dispersed.

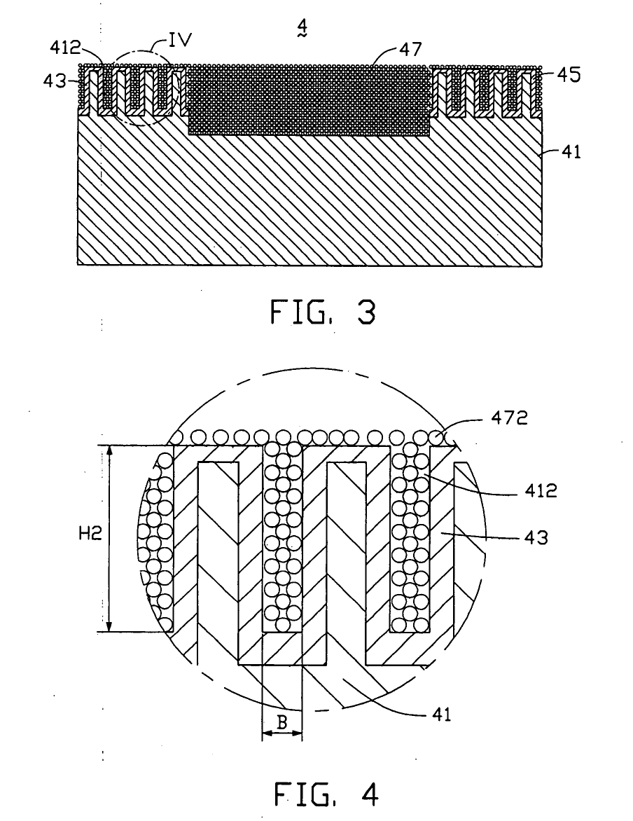

With reference to FIG. 3, a gas sensor 4 according to an alternative embodiment of the present invention comprises an insulating substrate 41, two separated electrodes 43, 45, and a sensing layer 47 formed on the insulating substrate 41 and electrodes 43, 45. The insulating substrate 41 has a plurality of channels 412 defined in opposite sides of a top portion thereof The electrodes 43, 45 cover inner surfaces of the channels 412, as well as top surfaces of the insulating substrate 41 which are between adjacent channels 41. The sensing layer 47 is similar to the sensing layer 37 of the preferred embodiment The sensing layer 47 covers surfaces of the electrodes 43, 45, as well as a recessed surface of the insulating substrate 41 between the electrodes 43, 45. Some sensing particles 472 contained in the sensing layer 47 are received in the channels 412.

Referring to FIG. 4, a portion of the gas sensor 4 is shown enlarged. The channels 412 are formed in the insulating substrate 41 by etching or lithography. Each electrode 43, 45 is preferably a thin film, with a thickness in the range from 100 nanometers to 300 nanometers.

Holding spaces provided by the channels 412 for the sensing particles 472 are narrowed and shortened, because the electrodes 43, 45 cover the inner surfaces of the channels 412. The narrowed holding spaces have an average width B and an average depth H2. Preferably, the average width B is 2 to 3 times an average size of the sensing particles 472. The average depth H2 is preferably ten times the average width B.

It will be understood by those skilled in the art that the sensing layers 37, 47 may cover the entirety of the surfaces of the respective electrodes 33, 35, 43, 45, or may cover only parts of said surfaces. The sensing particles 372, 472 may alternatively be distributed in only some of the respective blind holes 332, 352 and channels 412. Furthermore, the gas sensors 3, 4 may further include heating devices arranged under the respective insulating substrates 31,41.

It should be noted that the above-described gas sensors 3, 4 have been provided for the purposes of illustrating the present invention. Said gas sensors 3, 4 are not critical to practicing the present invention. A variety of conventional gas sensors are known to those skilled in the art, and may be suitably adapted for practicing the present invention.

Further, while the present invention has been described with reference to particular embodiments, the description is illustrative of the invention and is not to be construed as limiting the invention. Therefore, various modifications can be made to the preferred embodiments by those skilled in the art without departing from the true spirit and scope of the invention as defined by the appended claims.

1. A gas sensor comprising:
an insulating substrate;
two electrodes formed on the insulating substrate, each electrode defining a plurality of receptacles adjacent a surface thereof; and
a sensing layer containing a plurality of sensing particles, the sensing layer formed on the insulating substrate and the surfaces of the electrodes, a portion of the sensing particles being received in at least one of the receptacles.

2. The gas sensor as claimed in claim 1, wherein, the sensing particles comprise materials selected from the group consisting of tin oxide, wolframium oxide, and zinc oxide.

3. The gas sensor as claimed in claim 1, wherein the sensing particles are sized in the range from 5 nanometers to 100 nanometers.

4. The gas sensor as claimed in claim 1, wherein the receptacles are blind holes or channels.

5. The gas sensor as claimed in claim 1, wherein a ratio of an average depth of the receptacles to an average width of the receptacles is approximately ten.

6. The gas sensor as claimed in claim 1, wherein a ratio of an average width of the receptacles to an average size of the sensing particles is in the range from 2 to 3.

7. The gas sensor as claimed in claim 1, wherein a material of the insulating substrate is selected from the group consisting of quartz, a ceramic material, and silicon nitride.

8. The gas sensor as claimed in claim 1, further comprising a heating device adjacent the insulating substrate.

9. The gas sensor as claimed in claim 1, wherein the receptacles are formed in the surfaces of the electrodes by etching or lithography.

10. A gas sensor comprising:
an insulating substrate having a plurality of receptacles formed in a surface thereof;
two electrodes formed on the insulating substrate and covering inner surfaces of the receptacles; and
a sensing layer containing a plurality of sensing particles, the sensing layer formed on the insulating substrate and covering surfaces of the electrodes, a portion of the sensing particles being received in at least one of the receptacles.

11. The gas sensor as claimed in claim 10, wherein the sensing particles are selected from the group consisting of tin oxide, wolframium oxide, and zinc oxide.

12. The gas sensor as claimed in claim 10, wherein the sensing particles are sized in the range from 5 nanometers to 100 nanometers.

13. The gas sensor as claimed in claim 10, wherein the receptacles are blind holes or channels.

14. The gas sensor as claimed in claim 10, wherein a ratio of an average depth of the receptacles to an average width of the receptacles is approximately ten.

15. The gas sensor as claimed in claim 10, wherein a ratio of an average width of the receptacles to an average size of the sensing particles is in the range from 2 to 3.

16. The gas sensor as claimed in claim 10, wherein a material of the insulating substrate is selected from the group consisting of quartz, a ceramic material, and silicon nitride.

17. The gas sensor as claimed in claim 10, further comprising a heating device adjacent the insulating substrate.

18. The gas sensor as claimed in claim 10, wherein the receptacles are formed in the surfaces of the electrodes by etching or lithography.

19. A gas sensor comprising:
an insulating substrate;
two electrodes formed on the insulating substrate and cooperating with the insulating substrate to define a plurality of receptacles; and
a sensing layer having a plurality of sensing particles, the sensing layer formed on the insulating substrate and covering at least parts of surfaces of the electrodes at the receptacles, with at least a portion of the sensing particles being received in at least one of the receptacles.
